(19) United States
(12) Patent Application Publication
(10) Pub. No.: US 2017/0036876 A1
(43) Pub. Date: Feb. 9, 2017

(54) THIN GLASS LAMINATE

(71) Applicants: Takeshi Murashige, Ibaraki-shi (JP); Junichi Inagaki, Ibaraki-shi (JP); Seong Jin Ryu, Ibaraki-shi (JP)

(72) Inventors: Takeshi Murashige, Ibaraki-shi (JP); Junichi Inagaki, Ibaraki-shi (JP); Seong Jin Ryu, Ibaraki-shi (JP)

(73) Assignee: NITTO DENKO CORPORATION, Osaka (JP)

(21) Appl. No.: 15/331,429

(22) Filed: Oct. 21, 2016

Related U.S. Application Data
(62) Division of application No. 14/650,123, filed on Jun. 5, 2015.

(30) Foreign Application Priority Data
Dec. 6, 2012 (JP) 2012-266870

(51) Int. Cl. B65H 23/02; B32B 17/06

(52) U.S. Cl. CPC B65H 23/0204; B32B 17/064

(57) ABSTRACT

There is provided a thin glass laminate capable of preventing a thin glass from being broken when the thin glass laminate is subjected to processing or treatment by a roll-to-roll process.

A thin glass laminate according to an embodiment of the present invention includes: an elongated thin glass; and a protective film attached onto at least one surface of the elongated thin glass, wherein the elongated thin glass comprises, at both end portions in a width direction thereof, exposed portions each extending outward from an outermost end portion of the protective film in the width direction.

### CROSS-REFERENCE TO RELATED APPLICATIONS

This application is a divisional of U.S. application Ser. No. 14/650,123, filed on Jun. 5, 2015, which is a 371 of International Application No. PCT/JP2013/082658, filed on Dec. 5, 2013, which claims the benefit of priority from the prior Japanese Patent Application No. 2012-266870, filed on Dec. 6, 2012, the entire contents of which are incorporated herein by reference.

### TECHNICAL FIELD

The present invention relates to a thin glass laminate.

### BACKGROUND ART

In recent years, light-weighting and thinning of a display device, an illumination device, and a solar battery have been progressed from the viewpoint of transportation, storage, design, and the like. Further, continuous production has also been carried out to manufacture a film-shaped member to be used in those devices by a roll-to-roll process. For example, a thin glass is frequently used as a flexible material that may be subjected to processing or treatment by the roll-to-roll process (for example, Patent Literatures 1 and 2).

There is a problem in that the thin glass is liable to be broken in its processing or treatment owing to its extreme fragility and a device is fouled with glass pieces resulting from the breakage. In order to prevent the breakage of the thin glass, and to prevent the fouling of the device even when the thin glass is broken, a method of attaching a protective film onto a surface of the thin glass has been known (for example, Patent Literature 3). The protective film to be used in the method generally has a width equal to or larger than a width of the thin glass so that the protective film covers the entire surface of the thin glass. However, in the thin glass having attached thereto such protective film, an edge detector does not detect the thin glass itself but detects outermost end portions of the protective film even when the thin glass is taken up after passing through the edge detector. Therefore, it is difficult to take up the thin glass itself without skewing or meandering, and hence the thin glass has a problem of being broken owing to the skewing or meandering.

### CITATION LIST

### Patent Literature

[PTL 1] JP 01-500990 A

[PTL 2] JP 08-283041 A

[PTL 3] JP 2010-228166 A

### SUMMARY OF INVENTION

### Technical Problems

The present invention has been made to solve the above-mentioned problems inherent in the related art, and an object of the present invention is to provide a thin glass laminate capable of preventing a thin glass from being broken when the thin glass laminate is subjected to processing or treatment by a roll-to-roll process.

### Solution to Problem

A thin glass laminate according to an embodiment of the present invention includes: an elongated thin glass; and a protective film attached onto at least one surface of the elongated thin glass, wherein the elongated thin glass comprises, at both end portions in a width direction thereof, exposed portions each extending outward from an outermost end portion of the protective film in the width direction.

In one embodiment of the present invention, the elongated thin glass has a thickness of from 10 μm to 150 μm.

In one embodiment of the present invention, the exposed portions of the elongated thin glass each have a width of 1 mm or more.

In one embodiment of the present invention, a ratio of a width of the protective film to a width of the elongated thin glass is 50% or more.

In one embodiment of the present invention, the protective film includes a pressure-sensitive adhesive layer.

In one embodiment of the present invention, the pressure-sensitive adhesive layer has a pres sure-sensitive adhesive strength of from 0.005 N/25 mm to 2.0 N/25 mm with respect to the elongated thin glass.

In one embodiment of the present invention, the protective film has a thickness of from 3 μm to 250 μm.

In one embodiment of the present invention, the thin glass laminate is taken up into a roll shape.

In one embodiment of the present invention, a side surface of the thin glass laminate in a roll shape is protected with a protective material.

In one embodiment of the present invention, the protective material further protects an end portion of a surface of the thin glass laminate in a roll shape in the width direction.

According to another aspect of the present invention, there is provided a method of manufacturing the thin glass laminate. The method of manufacturing the thin glass laminate includes allowing the thin glass laminate to pass through an edge detector; and taking up the thin glass laminate into a roll shape.

### Advantageous Effects of Invention

According to the embodiments of the present invention, it is possible to provide the thin glass laminate including the elongated thin glass and the protective film attached onto at least one surface of the thin glass, in which the thin glass includes the exposed portions at the both end portions in the width direction so that the thin glass can be conveyed without skewing and meandering of the thin glass itself and can be taken up without rolling misalignment of the thin glass itself in a roll-to-roll process. As a result, the thin glass can be prevented from being broken in a take-up operation. In addition, in the thin glass laminate of the present invention, the protective film does not protrude from the thin glass. Therefore, even when the pressure-sensitive protective film is attached onto only one surface of the thin glass, the protective film does not adhere to a processing roll, and the thin glass is prevented from being broken in its processing or treatment.

### BRIEF DESCRIPTION OF DRAWINGS

FIG. 1 is a schematic sectional view of a thin glass laminate according to a preferred embodiment of the present invention.

### DESCRIPTION OF EMBODIMENTS

### <Entire Configuration of Thin Glass Laminate>

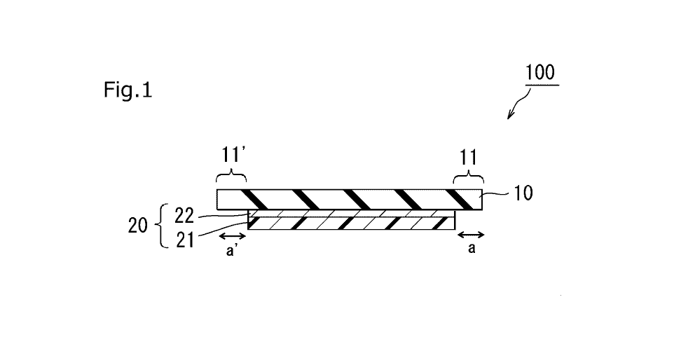

FIG. 1 is a schematic sectional view of a thin glass laminate according to a preferred embodiment of the present invention. A thin glass laminate 100 includes an elongated thin glass 10 and a protective film 20 attached onto one surface of the thin glass 10. The width of the protective film 20 is smaller than the width of the thin glass 10. In addition, the thin glass 10 includes, at both end portions in a width direction thereof, exposed portions 11, 11′ extending outward from the both end portions of the protective film 20 in the width direction. That is, the both ends of the protective film 20 in the width direction are located inside with respect to the both ends of the thin glass 10 in the width direction. The protective film 20 preferably includes any appropriate base material 21 and a pressure-sensitive adhesive layer 22, and is attached onto the thin glass 10 through the pressure-sensitive adhesive layer 22. The protective film 20 may be attached onto only one surface of the thin glass 10, or onto both surfaces thereof (attached onto one surface in the illustrated example).

In practical use, the thin glass laminate may be provided in a state of being taken up into a roll shape. The roll-shaped thin glass laminate may be subjected to processing or treatment by a roll-to-roll process. After the processing or treatment, the protective film is peeled off as necessary. Therefore, the protective film is preferably attached onto the thin glass so that the protective film can be peeled off therefrom. It should be noted that the rolled thin glass laminate as used herein is simply referred to as “roll” so as to be distinguished from processing rolls (such as a conveyance roll and a heating roll) installed in a processing/treatment device.

As described above, when the thin glass and the protective film are attached to each other so that the outermost end portions of the protective film in the width direction are located inside with respect to the thin glass, the thin glass laminate can be conveyed and taken up in the roll-to-roll process without skewing and meandering of the thin glass itself. More specifically, in the case of correcting skewing and meandering of the thin glass laminate by using an edge detector, the edge detector can detect the outermost end portions of the thin glass itself because the end portions of the thin glass laminate of the present invention in the width direction are each formed only of the thin glass. As a result, the skewing and meandering can be corrected based on the outermost end portions of the thin glass itself. In consequence, the thin glass itself can precisely be taken up without rolling misalignment even when the thin glass and the protective film are not strictly parallel to each other. In such thin glass laminate, the thin glass can be prevented from being broken in a take-up operation. In addition, also in the case of laminating another member (for example, a resin film) on the thin glass in the thin glass laminate by the roll-to-roll process, the laminate can precisely be obtained because the skewing and meandering of the thin glass itself can be corrected. Further, in the thin glass laminate of the present invention, the protective film does not protrude from the thin glass. Therefore, even when the pressure-adhesive protective film is attached onto only one surface of the thin glass, the protective film does not adhere to the processing roll, and the thin glass is prevented from being broken in its processing or treatment. Further, in the thin glass laminate of the present invention, one surface of the thin glass maybe exposed as described above, and hence the thin glass laminate can be subjected to various types of processing or treatment (for example, application of a resin, lamination of a resin film, sputtering, or photoresist) as compared to a thin glass in which both surfaces of the thin glass are protected.

The widths of the exposed portions of the thin glass (widths a, a′ of FIG. 1) may be constant or may not be constant in a length direction thereof as long as the both ends of the protective film in the width direction are located inside with respect to the both ends of the thin glass in the width direction. According to the present invention, even when the widths of the exposed portions are not constant (for example, when the protective film and the thin glass are not strictly parallel to each other), it is possible to provide the thin glass laminate that can be taken up by using an edge detector without skewing and meandering of the thin glass itself. In addition, the widths of the exposed portions may be the same as or different from each other in the width direction. The exposed portions of the thin glass each have a width of preferably 1 mm or more, more preferably 3 mm or more, still more preferably 5 mm or more. When the exposed portions of the thin glass each have a width falling within the above-mentioned range, a load applied to the end portions of the thin glass is reduced at the time of peeling of the protective film after completion of the processing or treatment, and hence the thin glass can be prevented from being broken.

In the thin glass laminate taken up into a roll shape, it is preferred that a side surface of the roll, that is, the thin glass exposed in the width direction be protected with a protective material. It is more preferred that the protective material further protect an end portion of a surface of the roll in the width direction. As the protective material, any appropriate protective material is used as long as the material can protect the thin glass exposed in the width direction. As the protective material, there may be used, for example, a disc-shaped protective material or disc-shaped protective material having a circumferential edge wall, which is formed of a plate made of a resin, a plate made of wood, a plate made of a metal, a plate made of paper, or the like.

### <Thin Glass>

As the thin glass, any appropriate thin glass may be adopted as long as the thin glass has a plate shape. As the thin glass, according to the classification based on a composition, there are given, for example, soda-lime glass, borate glass, aluminosilicate glass, quartz glass, and the like. Further, according to the classification based on an alkaline component, there are given alkali-free glass and low-alkali glass. Preferably, the alkali-free glass is used. This is because the alkali-free glass is excellent in strength and chemical durability.

As a method of forming the thin glass, any appropriate method may be adopted. Typically, the thin glass is manufactured by melting a mixture containing main raw materials such as silica and alumina, an antifoaming agent such as a salt cake and antimony oxide, and a reducing agent such as carbon at temperature of from 1,400° C. to 1,600° C. so as to form the mixture into a thin plate shape, and cooling the resultant. As a method of forming the thin glass into a thin plate, there are given, for example, a slot down-draw method, a fusion method, a float method, and the like. The thin glass formed into a plate shape by those methods may be reduced in thickness or subjected to chemical polishing with a solvent such as hydrofluoric acid, as necessary, in order to increase the smoothness.

The thickness of the thin glass is preferably from 10 μm to 150 μm, more preferably 20 μm to 120 μm, still more preferably 30 μm to 100 μm. In the case where the thickness of the thin glass is more than 150 μm, the thin glass does not have sufficient flexibility, and there is a risk in that the thin glass maybe difficult to take up into a roll shape. Further, in the case where the thickness of the thin glass is less than 10 μm, there is a risk in that the handling may be difficult.

The width of the thin glass is preferably 300 mm or more, more preferably 400 mm or more. In general, a wide thin glass is difficult to handle because a significant load is applied to the thin glass when the thin glass is twisted or deflected under the self weight. The present invention exhibits the effect markedly in the processing or treatment of the wide thin glass, which is usually difficult to handle. The upper limit of the width of the thin glass is preferably 1,500 mm or less, more preferably 1,200 mm or less.

The length of the thin glass may be set to any appropriate length in accordance with a desired treatment or processing amount. For example, the thin glass having a length of from 30 m to 1,000 m may be used.

### <Protective Film>

The lower limit value of the width of the protective film is a value of preferably 50% or more, more preferably 70% or more, still more preferably 90% or more, with respect to the width of the thin glass. When the width of the protective film falls within the above-mentioned range, the protective film can sufficiently protect the thin glass. The upper limit value of the width of the protective film is a value preferably equal to or less than (the width of the thin glass) −2 mm, more preferably equal to or less than (the width of the thin glass) −6 mm, still more preferably equal to or less than (the width of the thin glass) −10 mm.

The length of the protective film may be set to a length similar to that of the thin glass depending on a desired treatment amount or processing amount.

The thickness of the protective film is preferably from 3 μm to 250 μm, more preferably from 5 μm to 250 μm, still more preferably from 20 μm to 50 μm. When the thickness of the protective film is less than 3 μm, it may be difficult to laminate the protective film onto the thin glass. When the thickness of the protective film exceeds 250 μm, there is a risk in that the thin glass laminate has insufficient flexibility, and is not suitable for the roll-to-roll process.

The protective film preferably includes the base material and the pressure-sensitive adhesive layer. As a material for forming the base material, any appropriate flexible material may be selected as long as effects of the present invention are achieved. As such flexible material for forming the protective film, there is given, for example, a resin or a metal foil. Examples of the resin include polyethylene, polyvinyl chloride, polyethylene terephthalate, polyvinylidene chloride, polypropylene, polyvinyl alcohol, polyester, polycarbonate, polystyrene, polyacrylonitrile, an ethylene vinyl acetate copolymer, an ethylene-vinyl alcohol copolymer, an ethylene-methacrylic acid copolymer, nylon, cellophane, and a silicone resin. Of those, a polyethylene terephthalate-based resin or polyethylene is preferably used. Examples of the metal include aluminum, stainless steel, copper, iron, and lead. Of those, aluminum or stainless steel is preferably used.

For example, a rubber-based pressure-sensitive adhesive agent, an acrylic pressure-sensitive adhesive agent, a silicone-based pressure-sensitive adhesive agent, and a urethane-based pressure-sensitive adhesive agent are given as the material for forming the pressure-sensitive adhesive layer.

The thickness of the pressure-sensitive adhesive layer is preferably from 1 μm to 300 μm, more preferably from 4 μm to 100 μm, still more preferably from 5 μm to 50 μm.

The protective film including the pressure-sensitive adhesive layer has a pressure-sensitive adhesive strength of preferably from 0.005 N/25 mm to 2.0 N/25 mm, more preferably from 0.005 N/25 mm to 1.0 N/25 mm, still more preferably from 0.05 N/25 mm to 0.9 N/25 mm, with respect to the thin glass (the pressure-sensitive adhesive strength is substantially the pressure-sensitive adhesive strength of the pressure-sensitive adhesive layer). When the protective film has a pressure-sensitive adhesive strength falling within the above-mentioned range, the protective film can easily be peeled off from the thin glass laminate after the completion of the treatment or processing. It should be noted that the pressure-sensitive adhesive strength maybe measured as follows: the protective film is attached onto the thin glass so that the pressure-sensitive adhesive layer side faces the thin glass; and after the lapse of 30 minutes, the pressure-sensitive adhesive strength is measured with a pressure-sensitive adhesive strength measurement device (for example, an instron-type tensile tester, manufactured by Shimadzu Corporation, autograph) under the conditions of a temperature of 23° C., a humidity of 50% RH, a peeling direction of 180°, and a peel rate of 300 mm/min.

### <Method of Manufacturing Thin Glass Laminate>

The thin glass laminate of the present invention may be manufactured by laminating the protective film onto the thin glass by any appropriate method. For example, the lamination may be performed by a roll-to-roll process with a laminate roll or the like.

A method of manufacturing the thin glass laminate of the present invention preferably includes: allowing the thin glass laminate to pass through an edge detector; and taking up the thin glass laminate into a roll shape. In the present invention, the end portions of the thin glass laminate in the width direction are each formed only of the thin glass, and hence the skewing and meandering can be corrected by using the edge detector based on the outermost end portions of the thin glass. As a result, rolling misalignment of the thin glass itself can be suppressed, and the thin glass can be prevented from being broken. In addition, the thin glass laminate taken up into a roll shape as described above can be stably fed in a subsequent step, and the thin glass can be prevented from being broken also in the feeding. It should be noted that any appropriate method may be adopted as a method of correcting the skewing and meandering in the thin glass laminate subjected to the edge detection. For example, there is given a method involving moving the position of a conveyance roll or roll core in the width direction in response to the edge detection.

The method of manufacturing the thin glass laminate of the present invention preferably includes, after the take-up operation, protecting with the protective material the side surface and/or surface of the roll, the roll being the thin glass laminate in a roll shape. With this, the thin glass exposed in the width direction can be prevented from being broken. When the thin glass laminate is subjected to a subsequent step, the thin glass laminate is subjected to processing or treatment after the protective material is removed therefrom.

### INDUSTRIAL APPLICABILITY

The thin glass laminate of the present invention can be suitably used as a thin glass material to be subjected to the roll-to-roll process, such as a display substrate, a sensor cover, an element cover, or the like.

Reference Signs List

10 thin glass

20 protective film

100 thin glass laminate

1. A method of manufacturing a glass laminate, the method comprising:
allowing the thin glass laminate to pass through an edge detector; and
taking up the thin glass laminate into a roll shape,
wherein the thin glass laminate comprises,
an elongated thin glass; and
a protective film attached onto at least one surface of the elongated thin glass,
wherein the elongated thin glass comprises, at both end portions in a width direction thereof, exposed portions each extending outward from an outermost end portion of the protective film in the width direction.

2. The method of manufacturing the glass laminate according to claim 1, wherein the elongated thin glass has a thickness of from 10 μm to 150 μm.

3. The method of manufacturing the glass laminate according to claim 1, wherein the exposed portions of the elongated thin glass each have a width of 1 mm or more.

4. The method of manufacturing the glass laminate according to claim 1, wherein a ratio of a width of the protective film to a width of the elongated thin glass is 50% or more.

5. The method of manufacturing the glass laminate according to claim 1, wherein the protective film comprises a pressure-sensitive adhesive layer.

6. The method of manufacturing the glass laminate to claim 5, wherein the pressure-sensitive adhesive layer has a pressure-sensitive adhesive strength of from 0.005 N/25 mm to 2.0 N/25 mm with respect to the elongated thin glass.

7. The method of manufacturing the glass laminate according to claim 1, wherein the protective film has a thickness of from 3 μm to 250 μm.

8. The method of manufacturing the glass laminate according to claim 1, further comprising protecting a side surface of the thin glass laminate in a roll shape with a protective material.

9. The method of manufacturing the glass laminate according to claim 8, wherein the protective material further protects an end portion of a surface of the thin glass laminate in a roll shape in the width direction.
